(19) United States
(12) Patent Application Publication
(10) Pub. No.: US 2002/0138251 A1
(43) Pub. Date: Sep. 26, 2002

(54) Automated astrological data retrieval and analysis

(76) Inventor: Michael David Geary, Avon BA1 2QS (GB)

Correspondence Address: Robert E Cannuscio, Drinker Biddle & Reath, One Logan Square, 18th & Cherry Streets, Philadelphia, PA, 19103, US

(21) Appl. No.: 10/031,688

(22) PCT Filed: May 22, 2001
(86) PCT No.: PCT/GB01/02287

(30) Foreign Application Priority Data
May 24, 2000 (GB) 0012701.9

(51) Int. Cl. G06F 15/00

(52) U.S. Cl. 704/200

(57) ABSTRACT

An internet based system for generating and analysing astrological data in which numerical values representative of relationships between astrological conditions are identified and used in a calculation to determine a quantitative value for an activity type with respect to the astrological data.

The present invention relates to automated astrological data retrieval and analysis apparatus and method. Particularly, but not exclusively, the present invention is concerned with apparatus and a method that enables an analysis concerning prevailing astrological conditions, tailored to a person, group or other entity, to be automatically performed and the results communicated for example over the internet.

Astrology is the study of correlations between celestial events and man and has roots extending back at least as far as 3500 b.c. Whilst most people will have heard of the twelve signs of the zodiac this represents only a small portion of astrology. In Vedic astrology the twelve signs of the zodiac are aligned with 27 constellations or fixed star groups in the night sky about the Earth with Aries aligning with the first constellation called Aswini. This is described as a Sidereal zodiac and is different to the tropical zodiac of western astrology in which the point in space when the Sun crosses the earth's equator establishes the beginning point of the zodiac, or Aries.

Vedic and to a lesser extent western astrology seek to provide information on the varied psychological aspects of a person's nature as well as times when individual aspects of that character are likely to dominate. This can lead to the prediction/identification of time periods most suited to certain activities being performed by that person. Both forms of astrology are based upon charting the relative positions of astronomical features including the sun, the moon and the planets in Earth's solar system. A ‘native’ chart, which is also known as a natal chart, is a chart representing the relative positions of such astronomical features around the time and place of someone's birth. A transit chart, on the other hand, is a chart representing the relative positions of astronomical features at any particular time in any particular location and is usually compared against someone's native chart. Traditionally, the casting and reading of such charts could be reliably performed only by someone after lengthy study. Even today, although computer programs are available for determining the relative positions of the astronomical features relied upon in astrology, the interpretation of the significance of the relative positions, once plotted on a chart, remains the preserve of individual astrologers. Hence, anyone wanting to learn through astrology something of their psychological makeup and/or how this might affect events in their life, can only get such information through professional astrologers who will provide an interpretation of their relevant astrological data.

Conventional astrological readings are descriptive in their content and so only provide qualitative information on whether a particular time period is more suited to certain tasks or activities than an alternative time period. Such qualitative information leaves uncertainty for the person seeking the astrological reading as to the extent of any positive or negative influences during any particular time period.

The present invention seeks to provide an apparatus and method that automates the retrieval of astrological information and quantifies the qualitative assessment of events and activities in a person's life for selected time periods.

The present invention provides an astrological data analysis method comprising the steps of: calculating a plurality of transit astrological conditions on the basis of input native and transit data; identifying from an astrological database a plurality of numerical values representative of relationships between the calculated transit astrological conditions and an activity type; calculating in dependence on the numerical values identified a numerical score representative of the effectiveness, with respect to the activity type, of a subject with the input native data; and outputting a representation of the numerical score calculated.

Thus, the present invention provides both a qualitative and quantitative analysis of time, by reference to prevailing astrological conditions, and represents the multiplicity of variations in quality and intensity through the use of a numerical system that grades the influences on a scale, for example of between −10 to +10 where −10 represents the most adverse and intense conditions and +10 represents the most supportive, positive and conducive conditions.

With the present invention a numerical value is generated representative of the ‘power’ for a particular time period for the subject which furthermore can be rendered specific for a particular activity or event.

In a preferred embodiment the numerical values are identified by firstly selecting-from a rules database a plurality of relationships with respect to the transit astrological conditions and the activity type, each relationship identifying at least one constants label, and identifying from a constants database a numerical value for each constants label.

In an alternative aspect the present invention provides astrological software comprising: an astrological database containing a plurality of numerical values representative of relationships between transit astrological conditions and activity types; and a set of instructions for performing the following functions: calculating a plurality of transit astrological conditions on the basis of input native and transit data; identifying from the astrological database a plurality of numerical values representative of relationships between the calculated transit astrological conditions and an activity type; calculating in dependence on the numerical values a numerical score representative of the effectiveness of a subject with the input native data with respect to an activity type; and outputting a representation of the numerical score calculated.

In a third aspect the present invention provides astrological software suitable for use on a remote server comprising: an astrological database containing a plurality of numerical values representative of relationships between transit astrological conditions and activity types; and a set of instructions for performing the following functions: storing an activity type input from a remote terminal; identifying from the astrological database a plurality of numerical values representative of relationships between the calculated transit astrological conditions and an activity type; calculating in dependence on the numerical values a numerical score representative of the effectiveness of a subject with the input native data with respect to the activity type; and outputting to the remote terminal a representation of the numerical score calculated.

The astrological software may further include Ephemeris astronomical calculation routines from which astronomical data is derived dynamically based on transit data, and the set of instructions may further include coding for calculating the transit astrological conditions on the basis of the input transit data and the calculated astronomical data. In a fourth aspect the present invention provides astrological software suitable for use on a remote terminal comprising a set of instructions for performing the following functions: outputting to a remote astrological server a selected activity type; identifying native data and transit data for the calculation of transit astrological conditions; and receiving from the remote server a representation of a numerical score corresponding to the effectiveness of a subject with the native data with respect to the selected activity type.

In a fifth aspect the present invention provides astrological data analysis apparatus comprising: an input device for receiving native, transit and activity type data; a memory containing an astrological database containing a plurality of numerical values representative of relationships between transit astrological conditions and activity types; a first processor for calculating a plurality of transit astrological conditions on the basis of input native and transit data; a second processor for identifying from the memory a plurality of numerical values representative of relationships between the calculated transit astrological conditions and an activity type and for calculating in dependence on the numerical values a numerical score representative of the effectiveness of a subject with the input native data with respect to the input activity type; and an output for outputting a representation of the numerical score calculated.

Reference to the ‘power’ of a time period is intended as reference to the effectiveness with which tasks can be carried out during that time period. For example, for a time period having low power, the time would be utilised most effectively in low energy or mundane, repetitive activities whereas a high power time period would be utilised most effectively performing demanding and creative activities thus, the numerical scoring can be used to determine how powerful a particular individual can be in carrying out particular activities. Therefore, the score is attributed to a particular activity in a particular location over a particular time period. Also, the potential activity types for which numerical scores may be calculated includes no specific activity where the output representation of the numerical score relates to the general effectiveness of a subject with the input native details at the transit time and location.

Embodiments of the present invention will now be described by way of example with reference to the accompanying drawings, in which:

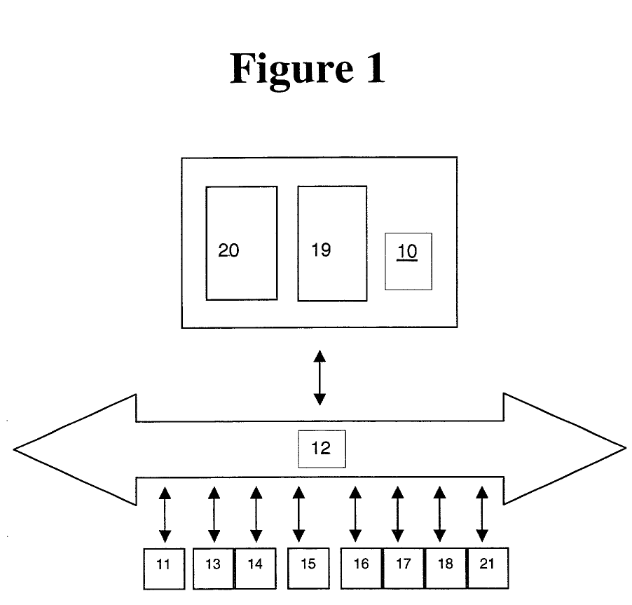

FIG. 1 illustrates astrological apparatus in accordance with the present invention;

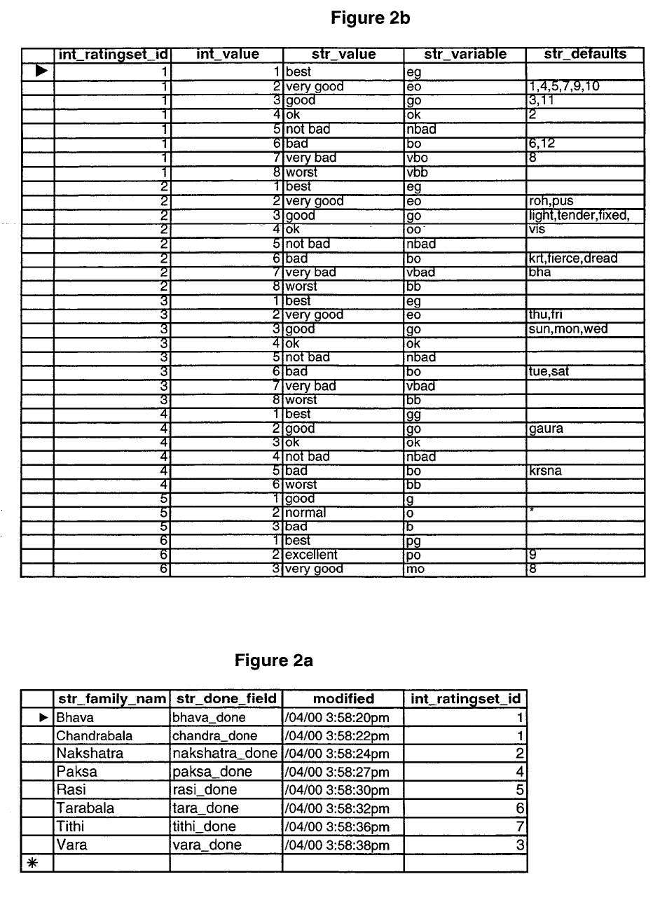

FIGS. 2a, 2b illustrate the data used in compilation of an Activity Table;

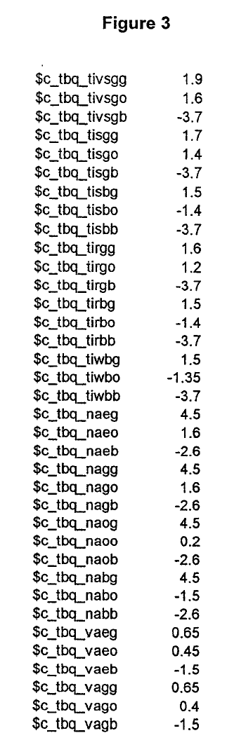

FIG. 3 shows a sample of the contents of a Value Set used in astrological apparatus in accordance with the present invention;

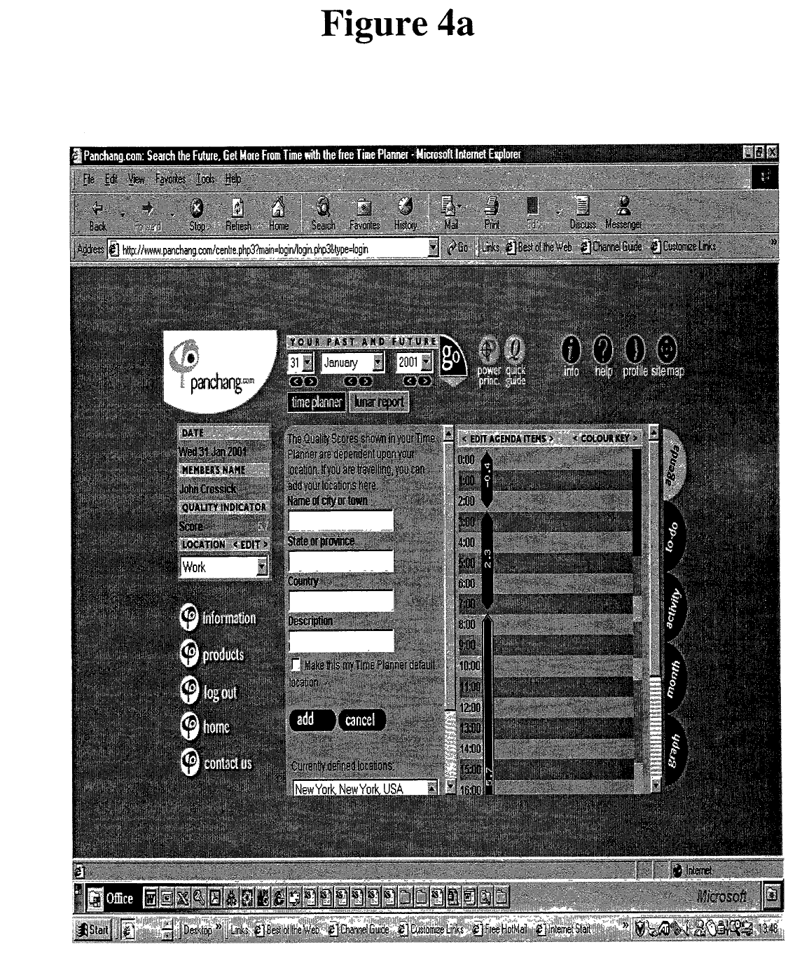

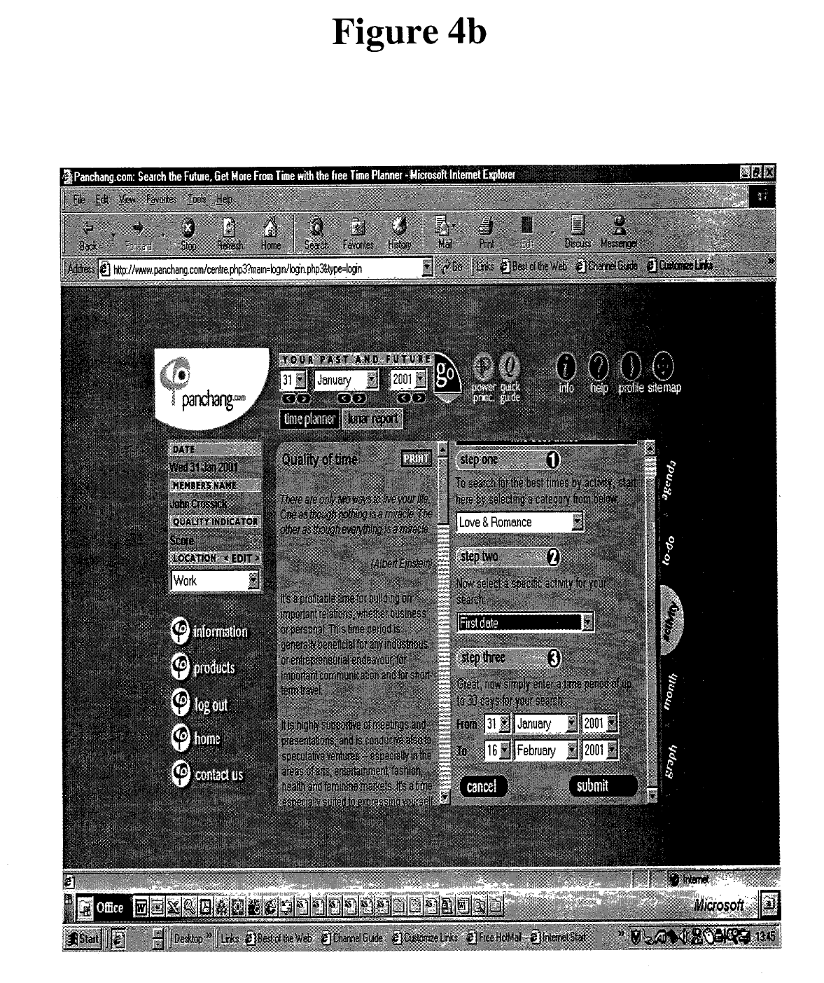

FIGS. 4a and 4b illustrate examples of screen displays for interrogation of astrological software in accordance with the present invention;

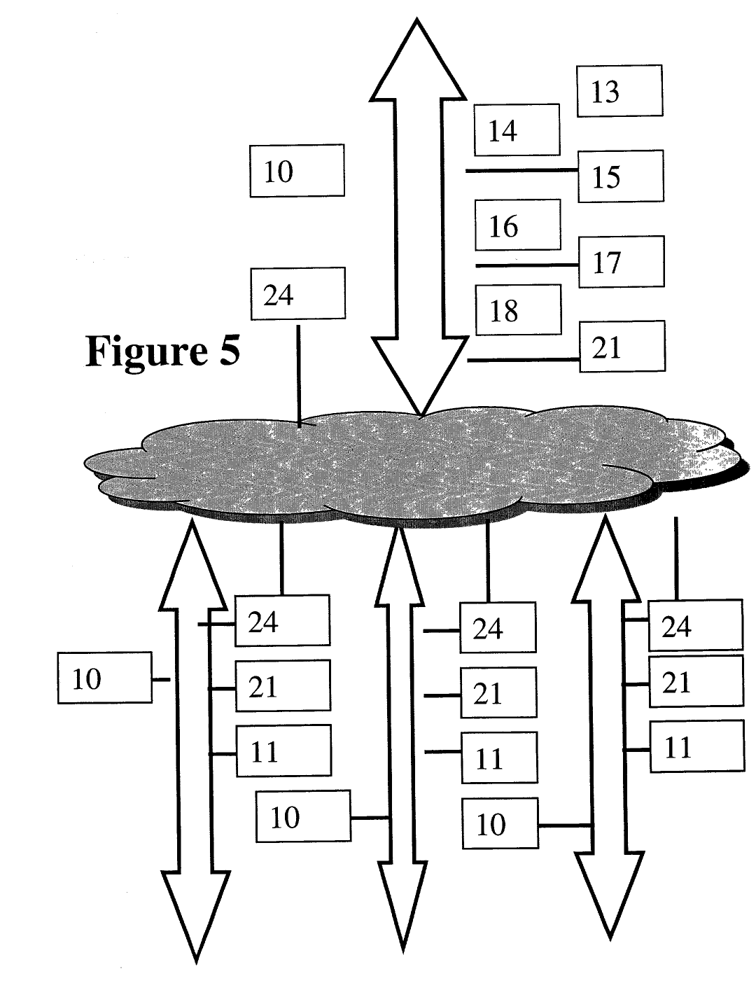

FIG. 5 illustrates an internet based astrological system in accordance with the present invention; and

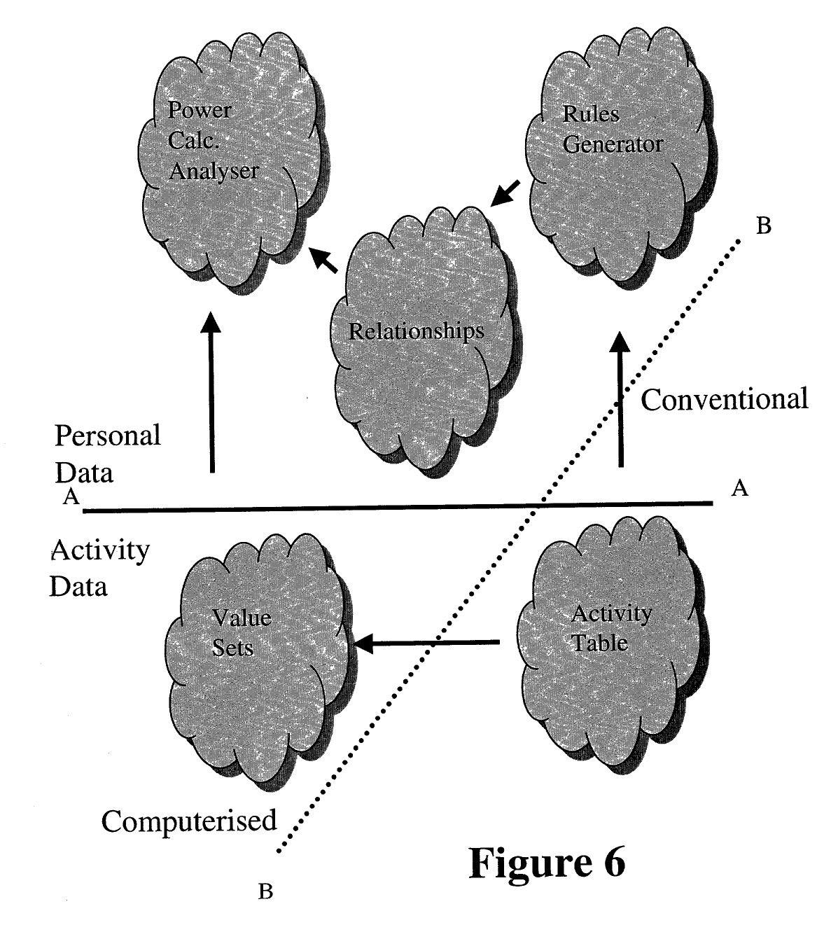

FIG. 6 illustrates a conceptual overview of the astrological apparatus and method in accordance with the present invention.

Astrological apparatus for automatically generating for a person, a group of people or an organisation a numerical value for the power of a time period is illustrated in FIG. 1. The astrological apparatus may be implemented as an astrological analysis software program on a conventional personal computer comprising a processing unit 10 and one or more input/output devices 11 communicating with the processing unit 10 via a bus 12. The input devices may include a keyboard and pointing devices such as a mouse or touch pad. The output devices may include a monitor and a printer. Once the astrological software is installed on a PC the following memory requirements are allocated memory: a ROM 13, RAM 14, first second, and third EEPROMs 15, 16, 17 and an intermediate buffer memory 18. Although the memory requirements have been described above as separate memory stores it will of course be appreciated that, in practice, individual memory stores are not employed and the contents of the computer's memory is more flexible in meeting the demands of the astrological analysis software. To assist in an understanding of the astrological software, reference will be made to the individual memory stores or regions as set out above.

The ROM 13 has stored within it Ephemeris data which consists of data regarding the relative positions of the Sun, the Moon and various planets, namely Mercury, Venus, Mars, Jupiter and Saturn, with respect to the geographical position of an observer on Earth and time. In Vedic astrology those astrological features such as planets that move relative to the stellar background are called “graha”. There are nine grahas in total: the Moon, the Sun, Mercury, Venus, Mars, Jupiter, Saturn, Rahu and Ketu. “Rahu” and “Ketu” are the two points (the ecliptics) where the moon crosses the path of the Sun; Rahu being the ecliptic when the moon is moving northwards and Ketu being the ecliptic when the moon is moving southwards. In addition, Vedic astrology requires information on the “ascendant” which is the zodiac sign that is crossing the eastern horizon during a selected time period at a selected location. The Ephemeris memory 13 thus contains data on each of the grahas and the ascendant with respect to time and observer location and this data is used in the calculation of native and transit charts. In practice, the Ephemeris data is based upon a fixed observer location and includes predetermined adjustments for geographical locations different from the fixed observer location.

The RAM 14 is used to store ‘native’ or ‘birth’ data on subjects for whom repeated astrological readings are to be generated. The subject may be a person or may be a group of people for example who form a business partnership or may be an even larger organisation. The information for each subject stored in the RAM consists of identification of the subject for example their name, and ‘birth’ data. In the case of a person the birth data consists of the geographical location of their birth, the year, date and time of their birth. For groups of people or an organisation such as a large multi-national company, more complex ‘birth’ information is required which may take account of the birth details of more than one person in the group or organisation and/or details on the formation of the organisation itself as an entity. In addition, for security purposes a password can be stored to restrict access to a subject's birth data. Storage of such information is not essential but simplifies repeated use of the astrological software as it avoids the need for the birth data to be entered by the subject each time the astrological software is run to obtain astrological information. The information may also include details of the subject's native chart, cast from the birth data provided.

The first EEPROM 15 contains a plurality of Value Sets, the second EEPROM 16 contains a plurality of Rules and the third EEPROM 17 contains an Activity Table each of which will be described in greater detail later. The intermediate buffer memory 18 functions in a similar manner to that of a cache in that data accessed from the Ephemeris memory 13, the birth data memory 14, and the EEPROMS 15 and 16 can be temporarily stored in the intermediate buffer 18 to speed up the astrological calculations. Although the Value Sets, the Rules and the Activity Table may be stored in one or more EEPROMS, it is envisaged that the contents of the Value Sets, the Rules and the Activity Tables may be regularly revised in which case more flexible data storage such as RAM is preferred. Also, for the purposes of the astrological apparatus and method described herein, the analysis data has been divided into the three sets listed above: Value Sets, Rules and an Activity Table. This organisation of the analysis data assists in an understanding of the astrological software structure and in practice it can be useful with respect to the speed with which the analysis data can be accessed and overwritten. However, alternative data structures could be employed and in particular the Value Sets and the Rules databases may be merged into a single astrological database.

In use, the user of the astrological software either enters the birth data of the subject for whom an astrological analysis is desired using a keyboard or other input device 11 or accesses the relevant birth data from the birth data memory 14. This data is transferred via the bus 12 to an astrological condition (ac) analyser 19 in the processing unit 10. The ac analyser 19 then accesses data from the Ephemeris memory 13 to calculate a native chart for the given birth data, if the native chart has not previously been stored in the birth data memory. The ac analyser 19 also calculates a transit chart either based on transit data such as a time and geographical location enter by the user or based on the computer's own internal clock (not shown) and geographical information previously stored by the computer. The native chart and the transit chart are then compared by the ac analyser 19 to identify and, where necessary, calculate a plurality of transit astrological conditions, which will be described in greater detail below, with respect to the transit chart.

Once the transit chart astrological conditions have been determined by the ac analyser 19, a power calc. analyser 20 in the processing unit 10 is enabled and the transit chart astrological conditions are transferred from the ac analyser 19 to the power calc. analyser 20. On the basis of the transit chart astrological conditions, the power calc. analyser 20 accesses from the Rules memory 16 a plurality of Rules on the basis of the transit astrological conditions. The Rules accessed from the Rules memory identify data from one or more Value Sets, stored in the Value Set memory 15. The power calc. analyser 20 therefore copies to the intermediate buffer 18 the Value Sets data identified in the Rules. The power calc. analyser 20 then calculates, using the data from the Value Sets temporarily stored in the intermediate buffer 18, a power that is a quantitative as well as a qualitative representation of the effectiveness of the time period of the transit chart under consideration. This is also called a “Quality Score” and provides an overview of the energy that a person experiences during the relevant time period and the effectiveness with which they will be able to deal with any tasks or events that arise during that time period. The power is calculated as a numerical value and may be output as a number or as a representation of the numerical value using alternative images such as a scale, gradation of colour or other symbolic devices.

With this astrological apparatus and method it is also possible perform a qualitative and quantitative analysis of time with respect to a specific-activity or event. In this case the power is calculated for a specific activity or event being/to be carried out by the subject during a time period for which a transit chart has been generated. In these circumstances the calculated numerical value of the power is called an Activity Score and equates to the effectiveness with which the subject will be able to attend to the particular activity or event under consideration during the selected time period.

To obtain an Activity Score the user enters using the input devices 11 the intended activity or event, the location and the birth details. The time period for the transit chart may be the current time or an alternative time period planned for the activity or event. The ac analyser 19 then calculates the transit astrological conditions in the same manner as described above. Once the transit astrological conditions have been supplied to the power calc. analyser 20, the Rules relevant to the particular activity or event that has been entered by the user are accessed in dependence on the transit astrological conditions. As before data in the Value Sets is then accessed by the power calc. analyser 20 with respect to the selected Rules. Thus, the Value Sets data is selected not only in dependence on the transit chart astrological conditions but also in dependence on the particular activity or event that has been input by the user. The resulting power or Activity Score calculated by the power calc. analyser is thus a qualitative and quantitative measure of the effectiveness of that particular subject performing the selected activity for example at the time and geographical location of the transit chart.

Although the ac analyser 19 has been described as separate from the power calc. analyser 20 they represent different programmed functions of the processing unit 10, the programming for which is stored in the program memory 21 of the computer. Hence, the functions of the ac analyser and the power calc. analyser are performed by the same data processing device 10.

There are many different kinds of astrological conditions that may be used in astrological analysis, however, in the present case 129 potential astrological conditions are considered which fall into eight types that are identified herein by their common sanskrit names: tithi, nakshatra, vara, paksa, rasi, tara-bala, chandra-bala and bhava. Tithi is the “Lunar Day” and is the angle between the sun and the moon in the transit chart which can be one of thirty different astrological conditions. Just as the sky is divided into twelve zodiac signs, the sky can also be divided into twenty-seven equal parts called nakshatras which correspond to specific constellations such as “Asvini” (Beta & Gamma Arietis) or “Rohini” (Aldebran). The number of the Naskshatra where the moon can be found in the transit chart is the second astrological condition type. Vara is the day of the week of the transit chart of which there are, of course, seven. Paksa is the phase of the moon for the transit chart which can be one of two astrological conditions: waxing or waning. Rasi is the zodiac sign in which the moon can be found in the transit chart of which there are twelve possible astrological conditions. Tara-bala is the angle between the moon's position in the transit chart and the moon's position in the native's chart measured in nakshatra and so in total there are twenty-seven potential astrological conditions in this group. Chandra-bala is the angle between the moon's position in the transit chart and the moon's position in the native's chart measured in zodiac signs and so in total there are twelve potential astrological conditions in this group. Finally, Bhava is the angle between the ascendant in the native chart and the moon in the transit chart measured in zodiac signs and so there are also twelve different potential bhavas. Thus, for any particular transit chart and native chart there are eight astrological condition Families. Complementary astrological conditions may of course be added. For example, as well as the twenty-seven nakshatra, navamsa may also be used which divide the sky into 108 parts giving further refinement to the analysis.

The Activity Table stored in EEPROM 17 consists of a long list of different activities to which each has been assigned a rating value for each of the astrological conditions mentioned above. Additional information such as the Value Set associated with each activity is also stored in the Table. When generating the Activity Table, default rating values are initially assigned by an astrologer for each of the astrological conditions for each activity in turn. These default rating values are then reviewed by the astrologer and adjusted so that the adjusted rating values are representative of the suitability of each astrological condition with respect to an activity or event. The Activity Table is not used during the normal operation of the astrological analysis software, its main function is in the referencing of Value Set data to create Rules. FIGS. 2a and 2b illustrating how the rating values are determined. In FIG. 2a each one of the eight types of astrological conditions is listed and is associated with a rating set. For example, chandra-bala is associated with rating set 2. Although not shown in FIG. 2a, the tara-bala and tithi types of astrological conditions may be subdivided so as to have different rating values and if necessary different rating sets for different divisions. For example, tara-bala may be divided into four divisions: division i) one nakshatra between the moon's position in the native chart and the transit chart; division ii) between two and nine nakshatra; division iii) between ten and eighteen nakshatra; and division iv) between nineteen and twenty-seven nakshatra. In FIG. 2b potential rating values for part of the various possible rating sets are illustrated. For rating set 2, for example, which from FIG. 2a has been assigned to the chandra-bala type of astrological condition, there can be seen to be eight possible rating values ranging from 1 for ‘best’ to 5 for ‘not bad’ and down to 8 for ‘worst’.

Different activities and events are related or associated as a result of the activities and events having similar or common astrological characteristics which enables the activities and events to be collated into a series of activity groups. The groupings of activities and events are not based on the physical nature or physical demands of the activities and events. Indeed, the astrological grouping of activities and events can often be surprising, for example creative writing and buying stocks have common astrological characteristics. Also, the activity of signing a mortgage agreement has similar astrological characteristics to those of the activities of negotiating a salary, going on a first date and going on a long holiday. Each one of these activity groups thus represents similar astrological characteristics and is assigned its own Value Set. Currently the astrological apparatus employs five Value Sets but this number may be increased or decreased depending upon the range of activities and events to be covered and the desired accuracy of the Activity Score. Similarly the Activity Table may be added to so as to increase the number and detail of the activities covered by the astrological software.

Each Value Set is thus assigned to a particular grouping of activities and events that, as mentioned above, are associated astrologically. One Value Set is independent of activities and events and is the Value Set used when a Quality Score rather than an Activity Score is desired. Each Value Set currently contains 80 uniquely identified pre-determined constants which populate the Value Set repeatedly each time being associated with an astrological condition. Naturally, if the number of astrological conditions and/or the nature of the astrological conditions used by the astrological software were to change, then the number of constants in each Value Set would change as might the value of each constant. Each constant is a number between −10 and +10 fixed to three decimal places and in FIG. 3 a sample of constants from Value Set tbq is illustrated. The tenth line down, for example, identifies a constant value of −3.7 for the astrological condition that is coded as tirgg. The codes on the left hand side in FIG. 3 are examples of the unique labels assigned to each and every constant. The activities that belong to the tbq Value Set include the activities mentioned earlier: i.e. signing a mortgage agreement and going on a long holiday.

The constants for the Value Sets are generated using comparative test cases. Initially, the constants are set to default values which can be reviewed by the astrologer and then the astrological software is run for a series of pairs of test cases. The most powerful case in the pair is determined by the astrologer and the resulting Activity Scores for each pair of test cases are reviewed by an astrologer and the constants in the relevant Value Sets adjusted where the Activity Scores do not accurately reflected the astrologer's analysis of the same pairs of data (ie the most powerful case does not yield the highest score). This procedure is continued until the constants in the Value Sets reach a steady state in which the astrological software produces results that consistently agreed with the astrologer's analysis. For ease of operation the pairs of test cases involve a common native chart but different transit charts which differ with respect to time. During the initial generation of the Value Sets the constants are also normalised so that the resultant Quality Scores and Activity Scores always fall with the range −10 to +10. In the event new activities are added to the Activities Table this may result in new Value Sets being added rather than the existing Value Sets being changed.

Although the range −10 to +10 is mentioned above, different numerical ranges may be adopted as desired to best represent the power of individual time periods.

The Rules memory 16 contains a large number of calculation rules (approximately 3,000) that may be performed by the power calc. analyser 20 to generate the Quality Score or the Activity Score. The calculations stored in the Rules consist of a series of simple additions of constants to be found in the Value Sets, with each of the constants identified by its unique label. As the constants in the Value Sets represent both positive and negative values, the addition of such constant will include subtraction where the constant has a negative numerical value. The total number of possible Rules establish the relationship between every potential activity/event and all potential groupings of astrological conditions. However, this total number includes redundancies and impossible groupings of astrological conditions. Thus, the total number of Rules can be reduced to approximately 3,000.

The power calc. analyser 20 accesses from the Rules memory 16 for the activity input by the user, which includes ‘no activity’ where a Quality Score is desired, the relevant relationships with respect to the input activity and the transit astrological conditions. The labels in the relationships accessed from the Rules memory 16 direct the power calc. analyser 20 to a particular Value Set stored in the Value Set memory 15. The power calc. analyser 20 caches that Value Set in the intermediate buffer 18 so as to speed up the acquisition of the particular constants required from the Value Set. The selected constants are then added and the result of the addition output by means of the output devices 11 as either a Quality Score or an Activity Score. The Quality/Activity Score may be output as a number in the range −10 to +10 or, as mentioned above, may be output using some form of symbolic representation of the numerical value.

Hence, the astrological apparatus and method described above generates a numerical value based upon the astrological conditions of a subject, and optionally a selected activity, that is representative of the power or effectiveness of the selected time period for that subject. The astrological apparatus and method described above avoids the inherent difficulties experienced with the qualitative astrological readings traditionally the preserve of trained astrologers and provides an automated system for generating a quantitative as well as qualitative astrological analysis. This astrological apparatus and method has been found to be extremely useful in maximising the efficiency with which both work and leisure can be conducted and in ensuring that work, in particular, may be appropriately apportioned.

Data generated by the astrological software described above can be presented as part of a diary or personal planner. Examples of one way in which the data may be presented are illustrated as screen displays in FIGS. 4a and 4b. The subject for whom the astrological analysis is required is identified under MEMBERS NAME along with the current date and a selected location on the left hand side of the screen display. These details are accompanied by a numerical value “4.5” in relation to QUALITY INDICATOR. This numerical value is the Quality Score that is calculated without reference to any particular activity. On the right hand side a daily diary is displayed divided into half hour segments and a series of coloured markers extend downwardly, across the time segments. A numerical value is also displayed on each of the coloured markers, e.g. “7.30”. This number is the Activity Score for a “meeting” conducted during the hours 1.00 and 7.30. The colour of the marker is also representative of the Activity Score and will change in colour in dependence upon the numerical value of the Activity Score. Instead of a daily diary, a month may be displayed on which the variations in the Quality Score during that month are presented or the variations in the Quality Score may be displayed as a graph. Also, a schedule of activities may be provided with respect to time periods for which the Activity Scores are particularly high. If will, of course, be appreciated that the screen displays shown in FIGS. 4a and 4b are only one illustration of the many ways in which Quality Scores and Activity Scores may be output to a user.

The software may also support functionality which allows one or more of the highest numerical activity scores over an input time range to be searched and displayed as shown in the central frame of FIG. 4b thus, as can be seen, there is a first selection box from which a plurality of activities are displayed from which the user selects one of the activities listed for example ‘Love & Romance’ along with a second selection box that permits greater specificity of the activity concerned. There is a third data entry section in which a user may enter their chosen time range or drop down menu may be employed for selection of the relevant time period. The input data is then used to calculate numerical activity scores for the selected activity in respect of each transit time period within the selected time range. One or more of the time periods having the highest activity scores are then displayed to the user.

FIGS. 4a and 4b are examples of screen displays that incorporate colour-coded representations of the nature of time, on the left hand side of the scroll bar in the ‘AGENDA’ tab. To determine the colour, an astrological condition database containing a plurality of rules relating astrological conditions with an associated numerical value. Transit astrological conditions are calculated from input transit data and the transit astrological conditions are compared to the astrological conditions in the astrological condition database. Where matches are found, the associated numerical value for the matched astrological condition are summed to generate a total. Certain pre-selected astrological conditions are not summed and instead alternative mathematical operators are employed to affect the final calculated total. Thresholds are used to group individual time periods into types with reference to their calculated total. Currently there are three primary time period types that are represented graphically through colour: red, amber and green with green representing the most favourable time period to act; amber representing a relatively neutral value; and red representing a negative time ill-suited to important action.

The astrological software described above was operable on a stand alone personal computer. However, the astrological software may also be implemented on an internet based system. FIG. 5 illustrates an internet based system with an astrological server 22 and three remote terminals 23. Each remote terminal 23 comprises a personal computer having its own input/output devices 11, program memory 21 and a network interface 24. Similarly, the astrological server 22 has a network interface 24 but also has the Ephemeris memory 13, the birth data memory 14, the Value Sets memory 15, the Rules memory 16, the Activity Table memory 17 and program memory 21. The astrological server 22 and the remote terminals 23 may communicate via the Web, for example, using any one of the many internet service providers now available. Alternatively, the astrological server 22 and the remote terminals 23 may communicate via an intranet using conventional gateway technology. The astrological server 22 operates in a similar manner to that described above except for the fact that the necessary birth data is input from a remote terminal via the network interface and the resultant Quality Score or Activity Score is output via the network interface to the remote terminal. Each of the remote terminals has comms data stored in the program memory 21 to enable the remote terminal to communicate with the astrological server 22. Additionally, an interrogation program is stored in the program memory 21 of the remote terminal to enable the necessary birth data and activity selection to be input via the remote terminal 23 to the astrological server. In an alternative embodiment the power calc. analyser 20 program may be stored in the program memory 21 of each of the remote terminals 23 so that whilst the astrological conditions are calculated by the remote server 22 and the relevant constants from the Value Set are identified by the astrological server the constants are then output from the astrological server 22 to the remote terminal 23 where the Quality Score or Activity Score is calculated. Other divisions between the operation of the remote terminals and the astrological server may, of course, be employed. For example, the remote terminal 23 may calculate the transit chart astrological conditions and then interrogate the astrological server 22 for the relevant constants on the basis of the selected activity and the transit chart astrological conditions that have been determined.

In FIG. 6 a conceptual overview of how the astrological software is constructed is illustrated. The construction of the astrological software may be divided into four parts: the Power Calc. Analyser; the Rules Generator; the Value Sets and the Activity Table. Each part communicates with its neighbours and enables a score being output by the Power Calc. Analyser. In constructing the databases which are required for the calculation of the Quality and Activity Scores, the Activity Table feeds data to both the Value Sets and the Rules Generator. In turn the Rules Generator produces a series of Rules or relationships with respect to activities and astrological conditions that are used in the calculation of Quality/Activity Scores. Boundary A marked in FIG. 6 identifies the boundary between the use of personal data (above boundary A) and activity data (below boundary A). Thus, the Activity Table and the Values Sets contain data solely relating to activities/events, not to transit chart astrological conditions. Similarly, boundary line B separates data arising from conventional astrology (to the left of boundary B) and data that is unique to the automated astrological software described herein (to the right of boundary B).

Although the Activity Table is not essential once the Value Sets and Rules have been generated, it may be retained where it is envisaged that the Value Sets and the Rules are to be regularly updated. The Quality Scores and the Activity Scores generated by the power calc. analyser may be used in a feedback mechanism to introduce further adjustments (fine tune) the Value Sets and Rules databases. This feedback mechanism may be manually controlled or automated. Similarly, new activities may be added through the Activity Table which would require corresponding adjustments to the Value Sets database and the Rules database.

Although the above astrological apparatus and method has been described with reference to a particular Vedic astrological analysis, it will be immediately apparent that the apparatus and method is equally applicable to other Vedic astrological analyses and to western astrology. Moreover, although reference herein has been made the use of the astrological software on a stand alone personal computer or over the internet, it is envisaged that other means of calculating and communicating the Quality Score and the Activity Score, possibly in combination with a remote server, are envisaged for example by means of digital television, using WAP with mobile phone telephony, and any embedded chip device such as watches or PDAs (Personal Digital Assistant).

1. An astrological data analysis method comprising the steps of:
calculating a plurality of transit astrological conditions on the basis of input native and transit data;
identifying from an astrological database a plurality of numerical values representative of relationships between the calculated transit astrological conditions and an activity type;
calculating in dependence on the numerical values identified a numerical score representative of the effectiveness, with respect to the activity type, of a subject with the input native data; and outputting a representation of the numerical score calculated.

2. The astrological data analysis method as claimed in claim 1, wherein the numerical values are identified by firstly selecting from a rules database a plurality of relationships with respect to the transit astrological conditions and the activity type, each relationship identifying at least one constants label, and identifying from a constants database a numerical value for each constants label.

3. The astrological data analysis method as claimed in either of claims 1 or 2, wherein the native data is stored in a native data memory and is accessed from the memory and automatically input for calculating the transit astrological conditions.

4. The astrological data analysis method as claimed in any one of claims 1 to 3, wherein a native chart based on the native data is stored in the native data memory and is accessed from the memory and automatically input for calculating the transit astrological conditions.

5. The astrological data analysis method as claimed in any one of claims 1 to 3, wherein a native chart based on the native data is generated prior to calculation of the transit astrological conditions.

6. The astrological data analysis method as claimed in any one of the preceding claims, wherein a transit time and a transit location are input for calculation of the transit astrological conditions.

7. The astrological data analysis method as claimed in any one of claims 1 to 5, wherein a transit time and a transit location are automatically generated for calculation of the transit astrological conditions.

8. The astrological data analysis method as claimed in claims 6 or 7, wherein a transit chart based on the transit time and transit location is generated prior to calculation of the transit astrological conditions.

9. The astrological data analysis method as claimed in any one of the preceding claims, wherein the numerical values are added together to generate the numerical score.

10. The astrological data analysis method as claimed in any one of the preceding claims, wherein the potential activity types includes no specific activity where the output representation of the numerical score relates to the general effectiveness of a subject with the input native details at the transit time and location.

11. The astrological data analysis method as claimed in any one of the preceding claims, wherein the numerical values are in the range −10 to +10.

12. The astrological data analysis method as claimed in claims 1 to 11, wherein the output is a number or an alternative image such as a scale of other symbolic device.

13. Astrological software comprising:
an astrological database containing a plurality of numerical values representative of relationships between transit astrological conditions and activity types; and
a set of instructions for performing the following functions:
calculating a plurality of transit astrological conditions on the basis of input native and transit data;
identifying from the astrological database a plurality of numerical values representative of relationships between the calculated transit astrological conditions and an activity type;
calculating in dependence on the numerical values a numerical score representative of the effectiveness of a subject with the input native and transit data with respect to an activity type; and
outputting a representation of the numerical score calculated.

14. Astrological software as claimed in claim 13, further including Ephemeris astronomical calculation routines for use in the calculation of the transit astrological conditions.

15. Astrological software as claimed in either of claims 13 or 14, wherein the potential activity types includes no activity such that the numerical score is representative of the general effectiveness of a subject with the input native data at the transit time and location.

16. Astrological software as claimed in any one of claims 13 to 15, wherein the astrological database comprises a rules database containing a plurality of relationships with respect to transit astrological conditions and activity types, each relationship containing a reference to at least one numerical constant value.

17. Astrological software suitable for use on a remote server comprising:
an astrological database containing a plurality of numerical values representative of relationships between transit astrological conditions and activity types; and
a set of instructions for performing the following functions:
storing an activity type input from a remote terminal;
identifying from the astrological database a plurality of numerical values representative of relationships between the calculated transit astrological conditions and an activity type;
calculating in dependence on the numerical values a numerical score representative of the effectiveness of a subject with the input native and transit data with respect to the activity type; and
outputting to the remote terminal a representation of the numerical score calculated.

18. Astrological software as claimed in claim 17, further including Ephemeris astronomical calculation routines, and the set of instructions further including coding for storing transit data input from the remote terminal and for calculating the transit astrological conditions on the basis of the input transit data and astronomical data derived from the Ephemeris routines.

19. Astrological software suitable for use on a remote terminal comprising a set of instructions for performing the following functions:
outputting to a remote astrological server a selected activity type;
identifying native data and transit data for the calculation of transit astrological conditions; and receiving from the remote server a representation of a numerical score corresponding to the effectiveness of a subject with the native data with respect to the selected activity type.

20. Astrological data analysis apparatus comprising:
an input device for receiving native, transit and activity type data;
a memory containing an astrological database containing a plurality of numerical values representative of relationships between transit astrological conditions and activity types;
a first processor for calculating a plurality of transit astrological conditions on the basis of input native and transit data;
a second processor for identifying from the memory a plurality of numerical values representative of relationships between the calculated transit astrological conditions and an activity type and for calculating in dependence on the numerical values a numerical score representative of the effectiveness of a subject with the input native data with respect to the input activity type; and
an output for outputting a representation of the numerical score calculated.

21. Astrological data analysis apparatus as claimed in claim 20 wherein the output is a number or an image such as a scale or other symbolic device.

22. Astrological data analysis apparatus as claimed in either of claims 20 or 21, further comprising a second memory containing astronomical data wherein the first processor calculates the transit astrological conditions on the basis of astronomical data accessed from the second memory.

23. Astrological data analysis apparatus as claimed in any one of claims 20 to 22, further including addition means for adding together the numerical values to generate the numerical score.

24. Astrological data analysis apparatus as claimed in any one of claims 20 to 23, wherein the numerical values in the first memory range between the values −10 to +10.

25. Astrological data analysis apparatus as claimed in any one of claims 20 to 24, further including a native data memory for storing native data.

26. Astrological Software as claimed in any one of claims 17 to 19, wherein the set of instructions includes instructions for calculating a plurality of numerical activity scores with respect to associated transit time periods within an input time range and for outputting one or more transit time periods having the highest activity scores.

27. Astrological time analysis software comprising:
an astrological condition database containing a plurality of astrological conditions and associated numerical values; and
a set of instructions for performing the following functions:
calculating a plurality of transit astrological conditions on the basis of input transit data;
comparing the transit astrological conditions with astrological conditions in the database and identifying associated numerical values for is those matched transit astrological conditions;
determining on the basis of the identified numerical values an overall numerical total for a particular time range;
comparing the numerical total with one or more threshold values to determine the nature of the time range which may be of two or more different levels; and
outputting a representation of the determined quality level.

28. Astrological time analysis software as claimed in claim 27 wherein each quality level is allocated a different colour.
